(19) United States
(12) Patent Application Publication
(10) Pub. No.: US 2004/0161728 A1
(43) Pub. Date: Aug. 19, 2004

(54) Distance learning system

(76) Inventors: Francis A. Benevento II, West Palm Beach, FL (US); Raymond F. Ratcliff III, Plano, TX (US)

Correspondence Address: PIPER RUDNICK LLP, 1200 NINETEENTH STREET N.W., WASHINGTON, DC, 20036-2412, US

(21) Appl. No.: 10/367,082

(22) Filed: Feb. 14, 2003

(51) Int. Cl. G09B 19/00

(52) U.S. Cl. 434/118

(57) ABSTRACT

The present invention relates to a system and method for generating customized lesson plans for distance learning courses, establishing improved communications during attendance of the courses, and ensuring the identity of students during testing on subject matter garnered from the courses and during privileged communications. Utilizing the disclosed invention, students for the first time, regardless of their type of school, economic/social strata or geographic location/isolation will be able to experience an individualized presentation and processing of their academic experience.

### BACKGROUND OF THE INVENTION

1. Field of the Invention

The present invention relates generally to distance learning systems and, more particularly, to a system and method for: generating a student's customized lesson plan for attending distance learning courses; establishing communications between and among instructors and students during their attendance of course classes, during recesses, and after scheduled classes; and ensuring the identity of a student during distance testing on subject matter garnered from a course or during any communication between a counselor and a student during or after a scheduled class.

2. Description of the Related Art

The United States educational system is confronted with increasing challenges as evidenced by rising costs, decreasing classroom performance, unfavorable test scores in comparison with other industrialized nations, increasing classroom diversity, and the recognition and necessary accommodation of students' learning differences and disabilities. Educational experts have come to realize that to meet these challenges the U.S. educational system cannot depend on a “one shoe-size fits all” program and must consider new ways to meet the unique needs and goals of each student. Notwithstanding improvements stemming from the ready availability of personal computers, access to the Internet, and school tuition voucher programs, the U.S. educational system remains virtually devoid of such personalization.

Efforts by both the public and private sectors have been made to meet the unique educational needs of students. Examples of such efforts include programs developed for taking courses over the Internet, systems for assessing students' knowledge, and curriculum delivery systems. Several of these efforts are described in more detail herein below.

Taking courses over the Internet (“distance learning”) is becoming a significant force in the United States. This is evidenced by the increasing number of school districts that are developing distance learning programs for their students. Examples of such programs include the Kentucky Virtual High School, Florida Virtual High School, and the Virtual High School of Hudson, Mass. In fact the longest running program, the Virtual High School of Hudson, Mass., has been in operation since 1996, offers 134 courses, and registered more than 2,000 students from across the globe in Spring 2002. Although relatively young, the Florida Virtual High School serves more than 10,000 students in 65 Florida districts. Distance learning schools typically offer courses as a supplement to students attending brick-and-mortar schools or to home schoolers.

A distinct disadvantage of many distance learning programs is that they do not sufficiently take into consideration the particular needs of each student—both with respect to addressing deficiencies in each student's knowledge and with respect to facilitating each student's efforts to reach their educational goals.

Efforts have been made to develop distance learning systems that address deficiencies in students' knowledge and facilitate the development of curriculums. However, the efforts fall far short of addressing today's educational challenges in the United States.

For example, U.S. Pat. No. 6,347,943 to Fields, et al. discloses a system that includes an authoring mechanism to create at least one knowledge base relating to a particular topic and an assessment mechanism to evaluate a user's knowledge on a particular topic and devise a course of instruction on the topic based on the assessed knowledge of the user.

During operation, a user first interacts with the assessment mechanism, which presents a series of assessment pages. The assessment pages include assessment tools in the form of multiple choice questions, fill-in-the-blank questions, or any other data structure to which a response from the user is required. After the user completes navigating through the assessment pages, the assessment mechanism determines which assessment tools were responded to incorrectly. For these incorrectly answered assessment tools, the system retrieves from a learning mechanism and research library data items that were previously linked by the authoring mechanism to the incorrectly answered assessment tools. Thus, the system provides to the user information that relates only to those sub-topics for which the user was assessed as having inadequate knowledge.

As a further example, U.S. Pat. No. 6,343,319 to Abensour, et al. discloses a computerized curriculum capture, organization and delivery system and method. Such system and method includes a data gathering mechanism that defines and downloads a quantity of data from a data source pertaining to a selected curriculum topic and a data organizing mechanism that partitions the data into curriculum units. The data organizing mechanism arranges and interlinks the curriculum units into a lesson web having an interactive format. The server delivers the quantity of data to the data delivery mechanism and the data delivery mechanism delivers the quantity of data to the receiver in interactively-accessible segments. The data delivery mechanism and server deliver commands input into the end user receiver input mechanism to the data storage mechanism in a continuing interactive pattern.

Non-academic distance learning systems have also been disclosed in the art. For example, distance learning systems are known for improving a golfer's swing via a network of computers. However, these systems also fall far short of addressing today's educational challenges.

As an example, U.S. Pat. No. 6,293,802 to Ahlgren discloses a system for distance learning that utilizes a capture station in conjunction with an analysis station at a remote location to provide remote training for a golf student. According to the invention, the golf student has a video of his swing that is captured on video at a capture station. The captured motion is forwarded to a remote analysis center where it is reviewed by an instructor. The instructor prepares a personalized lesson for the student, instructing the student how he might improve his swing. The personalized lesson is forwarded to the student at the capture station where it is reviewed by the student. The instructor can add additional information to the personalized lesson such as graphic overlays to illustrate suggested improvements to the student's swing. The instructor can also include vocal/audio recordings and narration. The instructor may also provide prerecorded materials as part of the personalized lesson including drills, exercises, and instructions.

Similarly, U.S. Pat. No. 6,159,016 to Lubell, et al. provides a system for producing a personal golf lesson videotape from a visual recording of a person's golf swing and a partially prerecorded instructional golf lesson videotape. The partially prerecorded golf lesson videotape has gaps in predetermined locations into which are inserted the full motion video of the person's swing and selected still frames. In addition, U.S. Pat. No. 5,486,001 to Baker discloses a system for receiving a first set of images of a student golfer's swing, comparing the first set of images to a second set of images of a preferred golfer's swing, and generating a third set of images, wherein the third set of images are the first set of images that have been adjusted to emulate the preferred second set of images. The third set of images are transmitted to the golfer for his review.

Present distance learning systems provide classes that are, for the most part, synchronous. That is, they provide classes where several students log onto a system simultaneously and receive a lesson in real time. In this regard, it should be appreciated that an advantage of such distance learning systems is the convenience in receiving a diverse course of study without having to physically travel to a learning institution to attend classes. On the other hand, a significant disadvantage of such distance learning systems is the lack of interaction between an instructor and his students, an individual student and the instructor, and between the students.

U.S. Pat. No. 6,347,943 to Fields, et al. provides a communication system that allows distance learners to communicate with other distance learners on the system by holding line-by-line chat sessions and by allowing them to push web pages between each other. The chat-session portion of the system operates similar to the popular Instant Messaging system offered by America Online, Inc. (Dulles, Va.). Although the disclosed system improves communications between distance learners, it is still lacking in that it does not significantly replicate the face-to-face learning experience.

In instituting any distance learning study program, testing of course subject matter is typically required to monitor each student's progress. When a distance learner takes a test, it is imperative that the student's identification is verified in order to give credibility to the study program. That is, the entity performing the testing must ensure that the individual taking the test is, in fact, the same individual that is enrolled in the study program.

Efforts have been made to verify the identity of home test takers in the past. U.S. Pat. No. 5,700,149 to Johnson, et al. discloses a system for testing a course of study that employs a set of questions directed to both the course of study and to personal validation. The system measures the elapsed time between the communication of personal validation questions and the receipt of answers to such questions. The system authenticates the identity of the student answering the questions based on the answers and the elapsed time to provide such answers. Similarly, U.S. Pat. No. 5,458,494 to Krohn, et al. discloses a phone system over which a student may listen to lectures. In order to receive the lecture the student may have to enter an identification code which is intended to verify the students identification. The disclosure further includes a mode in which distance learners are required to enunciate a short phrase so that their voice patterns can be compared to previously stored voice patterns of the same distance learners to verify the identity of the distance learners as a means to assure that students are not placing calls for one another.

Systems have also been devised to require the input of biometric data to verify the identity of a student taking a test at a remote location. For example, U.S. Pat. No. 6,163,616 to Feldman discloses a system for verifying the identity of a person while taking an examination on a computer. The system is based on a relationship between the anatomic structures of the person's hand when operating a mouse with their hand while in contact with a touch-sensitive surface.

Similarly, U.S. Pat. No. 5,947,747 to Walker, et al., discloses a system that provides for including corroborative data in the encoded score code transmitted from the testing computer to a central computer. Such corroborative data could include a biometric identifier of the user or of a witness to the testing (e.g., a proctor), other forms of witness identifiers entered via a keypad or other input device, or a location datum from a GPS receiver to provide corroborative datum indicating the location of the testing computer. Examples of biometric identification devices include a fingerprint reader, voice recognition system, or retinal scanner. During testing, biometric data is compared against previously stored data of a student. If the data does not match, access to the test can be terminated. This procedure may be implemented before the start of a testing session, during a testing session in response to prompts from the educational software, at some predetermined or random time, or continuously during testing.

As a further example, U.S. Pat. No. 5,915,973 discloses a system wherein the proctoring data is audio/visual data of the testing event. The proctoring data preferably includes an audio/visual record of input of test taker biometric data and input of test response data. The proctoring data further includes a still picture of the test taker. The biometric data is compared to biometric data stored on a central computer and the proctoring data is reviewed for invalidating events.

Accordingly, what is needed is a system and method that simplifies the process of developing a lesson plan that is directed towards the needs and goals of a student. Ideally, the lesson plan should be personalized. In addition, the system should replicate as closely as possible a face-to-face class experience. Furthermore, the system should ensure that any tests taken through the system are in fact taken by the student assigned to the distance learning class and that the identity of participants in related online communications can be verified.

### SUMMARY OF THE INVENTION

A system and method is disclosed for developing a lesson plan over an electronic network for a distance learner. The method includes the steps of receiving background data of a distance learner; receiving course content from one or more course content providers; applying a rule set to the background data and course content to determine a lesson plan that includes two or more courses from the course content of the one or more course content providers; and transmitting the lesson plan to the distance learner.

The background data may include data selected from the group consisting of a goal, profile information, and an academic record of the distance learner. For example, the goal may be learning about modern art, obtaining a certificate in automotive repair, preparing for the Engineer-In-Training examination, receiving a bachelor's degree in software engineering, and/or meeting educational objectives of an Individualized Educational Program (“IEP”) developed by any school and/or State or municipality (or educational system thereof) under the Individuals with Disabilities Education Act (“IDEA”).

The profile information may include information concerning the distance learner's age, languages spoken, learning differences, and working schedule. The academic record may include information pertaining to: the results from a learning difference evaluation; scores from a Wechsler Intelligence Scale for Children test (“WISK”), National Education Development Test (“NEDT”), General Education Development test (“GED”), Scholastic Aptitude Test (“SAT”), Medical College Admission Test (“MCAT”), and/or Law School Admissions Test (“LSAT”); transcripts from pre-kindergarten, kindergarten, primary school, high school, college and/or grad/professional school; comments or evaluations from an instructor, tutor, advisor and/or psychologist, and/or historical use of previously developed lesson plans.

The rule set may be provided by the one or more course content providers. Exemplary rule sets include curriculum-building rules, course time-bar rules, GPA threshold rules, prerequisite rules, course/course conflict rules, and/or work/course conflict rules.

The method may further include the step of transmitting course videos, exercises, and tests to the distance learner in accordance with the lesson plan. The method may further include the step of receiving data from the distance learner identifying one of the course content providers whose course content is to be used to make up the lesson plan. The method may further include the step of transmitting one or more specialized tests to the distance learner to evaluate the his deficiencies in selected topics. The method may further include the step of transmitting the lesson plan to an instructor or IEP Team member for review. The method may further include the step of receiving a modified version of the lesson plan from, for example, an instructor, IEP Team member, or the distance learner.

The method may further include the step of a student (including the legal representative thereof), instructor, school or school system (including any State or municipality) posting in any forum or media (including any electronic network) the special needs of a student or group of students, such as lesson plans (including lesson plans based on IEPs), and descriptions of learning differences, for the purpose of eliciting proposals from, for example, schools, school systems, and instructors for meeting such special needs.

Also disclosed is a system and method for enabling an instructor to control a presentation of image and/or audio data on one or more client computers of students attending a distance learning class and, if applicable, of students in a conventional classroom thereby communicating with the distant learners. The method includes providing controls to a instructor that enable the instructor to configure the presentation of image and/or audio data on one or more client computers of distant learners and, if applicable, of students in a conventional classroom thereby communicating with the distant learners; receiving from the instructor control data that represents a first presentation configuration and identifies at least one of the one or more client computers that are to receive image and/or audio data in conformance with the first presentation configuration; and transmitting image and/or audio data in conformance with the first presentation configuration to the at least one of the one or more client computers.

The image data may be, for example, image data of an instructor, image data of one or more students, image data of a video presentation, or any combination thereof. The audio data may be, for example, audio data of the instructor's voice, audio data of one or more students' voices, audio data of an audio presentation, or any combination thereof.

The method may further include the step of receiving from the instructor control data that represents a second presentation configuration and identifies at least one or more client computers that are to receive image and/or audio data in conformance with the second presentation configuration. It is notable that less than all of the client computers may receive image and/or audio data in conformance with the first presentation configuration and the remainder of the client computers may receive image and/or audio data in conformance with the second presentation configuration. Additional presentation configurations can be made.

The method may further include the steps of receiving from the instructor control data that identifies an assistant that is to receive auxiliary controls and providing the auxiliary controls to the assistant so the assistant can configure the presentation of image and/or audio data on one or more client computers of students attending the distance learning class and, if applicable, students in a conventional classroom thereby communicating with the distant learners. The assistant may be a distance learner. The assistant may receive auxiliary controls for a number of purposes including leading a study group, leading an exercise group, and tutoring a student.

The controls provided to the instructor for controlling the presentation of images and audio on the students' client computers may include a presentation control screen having a configuration panel, an active window, and an attendee window. An exemplary presentation configuration includes providing images and audio of the instructor positioned in the upper portion of a screen and images of the students attending the distance learning class positioned in the lower portion of the screen. The distance learning class may be synchronous or asynchronous and may be conducted over any electronic network.

Also disclosed is a system and method for ensuring the identity of a student taking a test over an electronic network. The method includes transmitting a test to a client computer of a student; receiving a first set of data representative of a physical characteristic of the student; comparing the first set of data to a second set of data representative of the physical characteristic of the student to verify the identity of the student; receiving a continuous stream of confirmation data of the student that begins at a time about when the first set of data was created and ends at a time about when the student completes the test or counseling; and analyzing the continuous stream of confirmation data to ensure the confirmation data satisfies predefined rules.

The first and second sets of data may include biometric data selected from the group consisting of scanned finger print data, scanned retina data, and voice print data. The continuous stream of confirmation data may be a continuous stream of video data having a frame rate selected from the group consisting of about 30 frames/second, 1 frame/second, and 1 frame/3 seconds. The predefined rules may initiate a signal when the average gray-scale value of a region-of-interest in frames of video deviates beyond a predetermined range. The average gray-scale value of the region-of-interest may be calculated from each frame, regularly occurring groups of frames, or randomly selected frames the video.

The method may further include the step of transmitting a signal to the client computer to cause the test to discontinue when the confirmation data does not satisfy the predefined rules. The method may further include the steps of receiving the completed test from the student and grading the test.

Also disclosed is a system and method for ensuring the identity of a student when communicating with a counselor over an electronic network. The communication may be for academic, psychiatric, psychological, and/or career counseling purposes. The method may include the steps of initiating a communication between a counselor and a student; receiving a first set of data representative of a physical characteristic of the student; comparing the first set of data to a second set of data representative of the physical characteristic of the student to verify the identity of the student; receiving a continuous stream of confirmation data of the student that begins at a time about when the first set of data was created and ends at a time about when the communication between the counselor and the student is terminated; and analyzing the continous stream of confirmation data to ensure the confirmation data satisfies predefined rules.

The step of initiating a communication between a counselor and a student may be caused by one of the counselor and the student sending an electronic message to the other of the counselor and the student requesting such communication. The method may further include the step of transmitting a signal to the counselor that confirms the identity of the student, wherein the confirmation signal is received by the counselor throughout the communication between the counselor and the student.

### BRIEF DESCRIPTION OF THE FIGS.

A more complete appreciation of the invention and the advantages thereof will be more readily apparent by reference to the detailed description of the preferred embodiments when considered in connection with the accompanying figures, wherein:

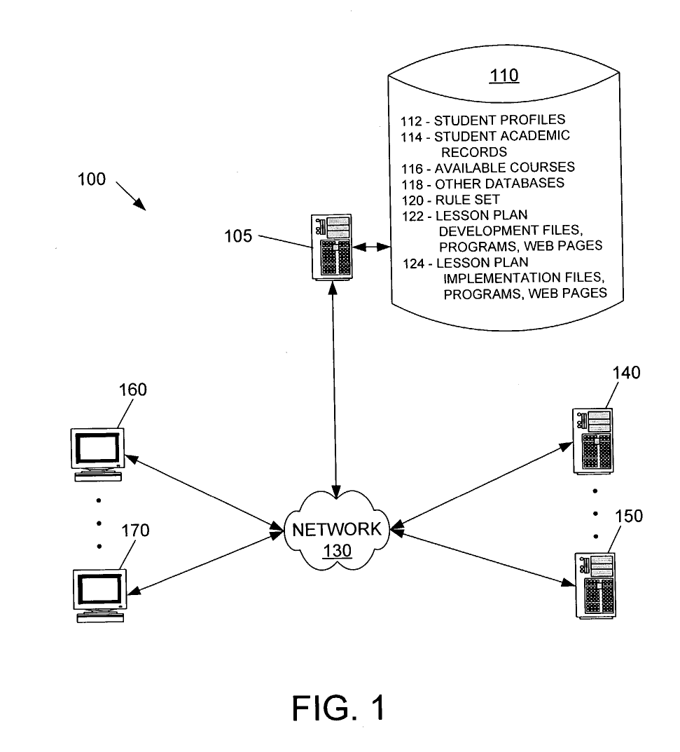

FIG. 1 is a diagram of a computer system that may be used in the present invention;

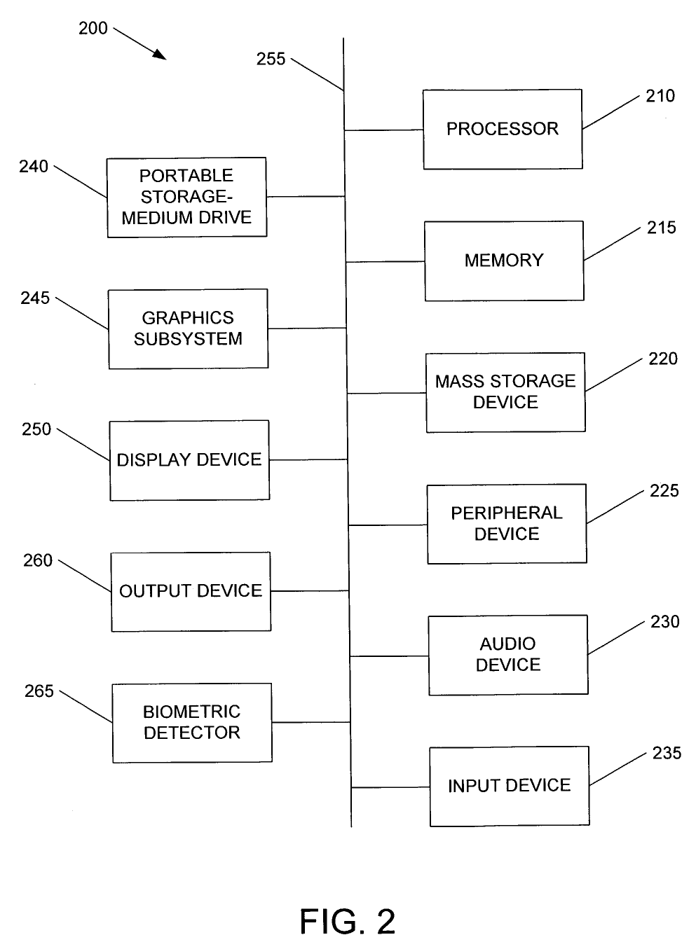

FIG. 2 is a block diagram view of a general purpose computer that may be used in the computer system illustrated in FIG. 1;

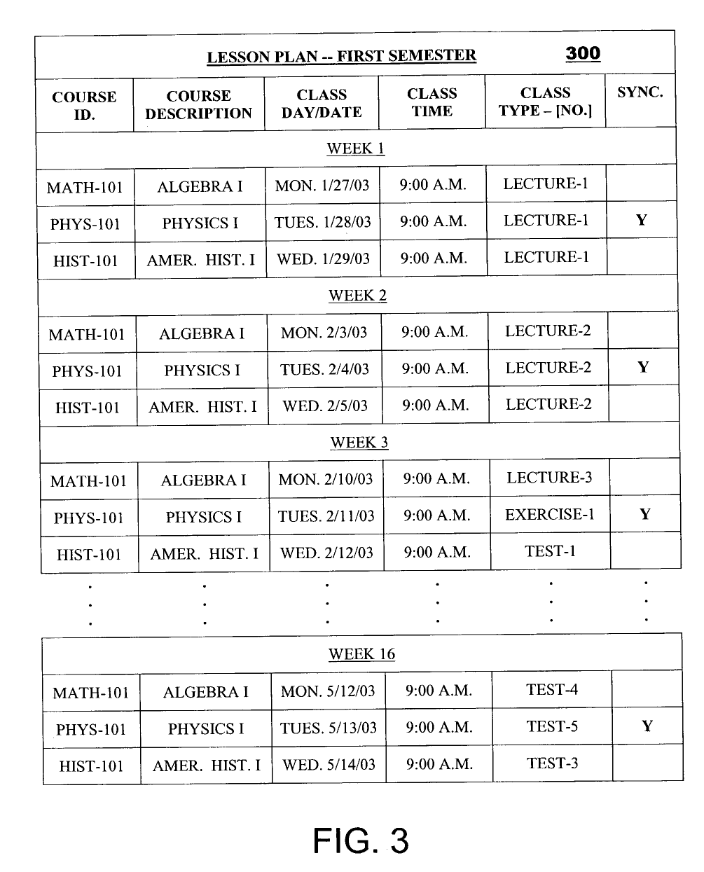

FIG. 3 is an exemplary customized lesson plan created with a method of the present invention;

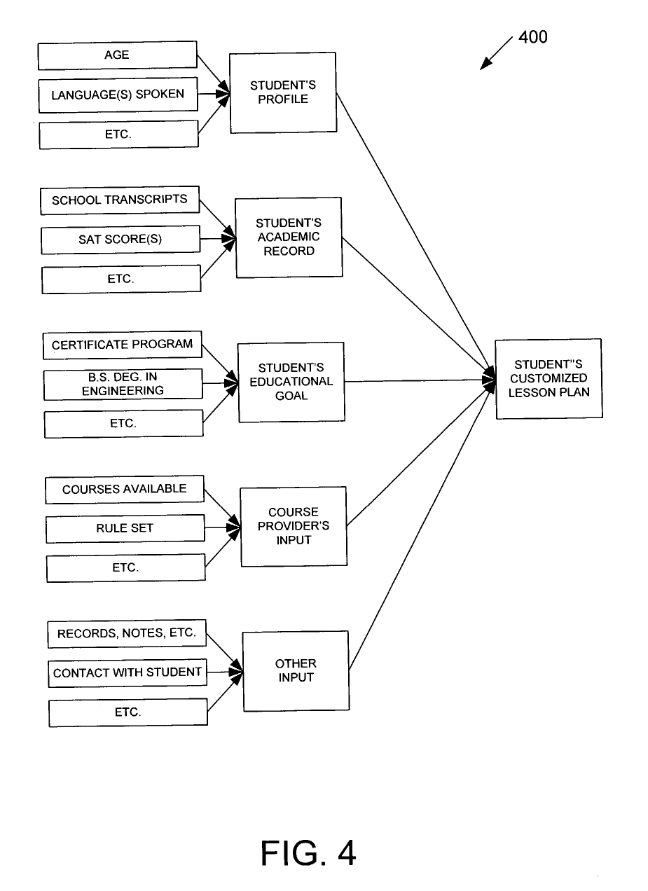

FIG. 4 is a block diagram showing the flow of information that may be used to develop a customized lesson plan;

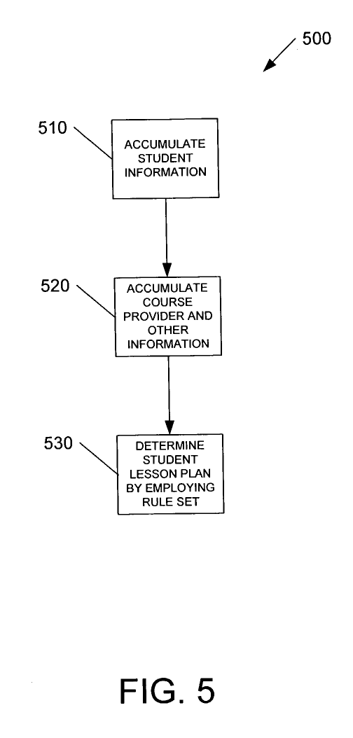

FIG. 5 s a flow diagram showing generally an embodiment of a method of the present invention for creating a customized lesson plan;

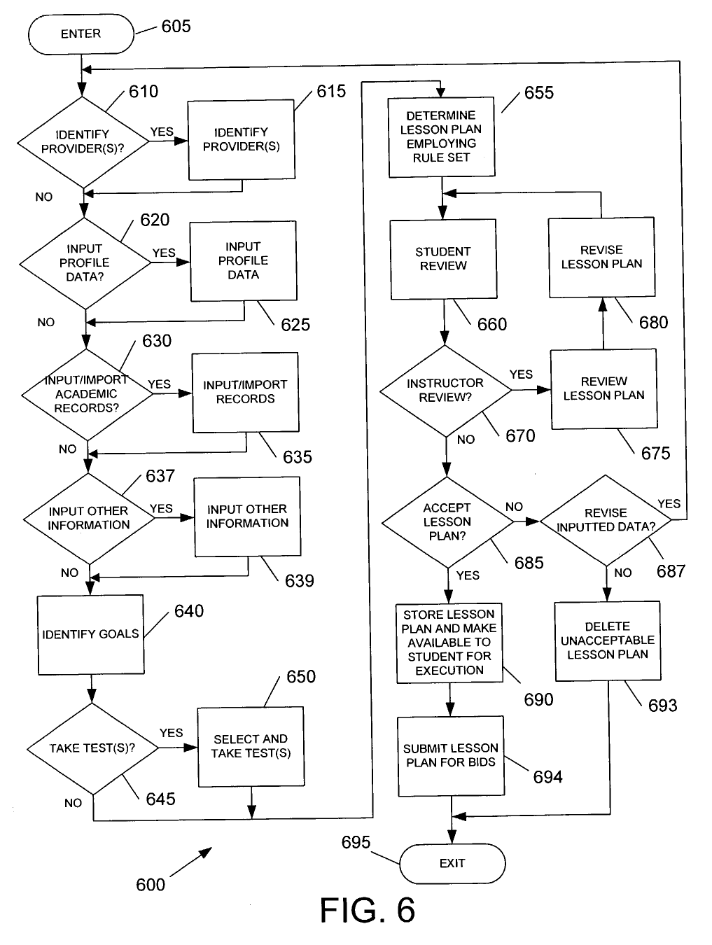

FIG. 6 s a flow diagram showing a detailed embodiment of a method of the present invention for creating a customized lesson plan;

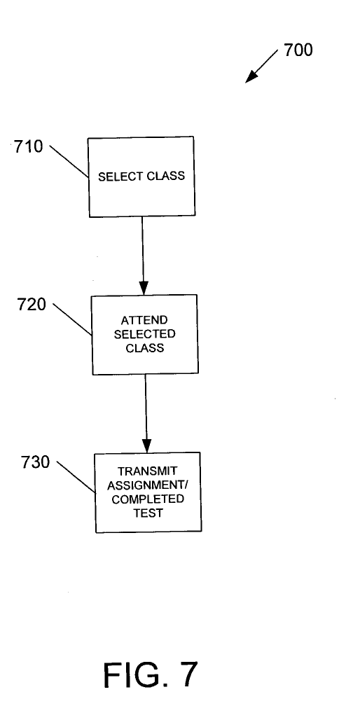

FIG. 7 is a flow diagram showing generally an embodiment of a method of the present invention for using a customized lesson plan;

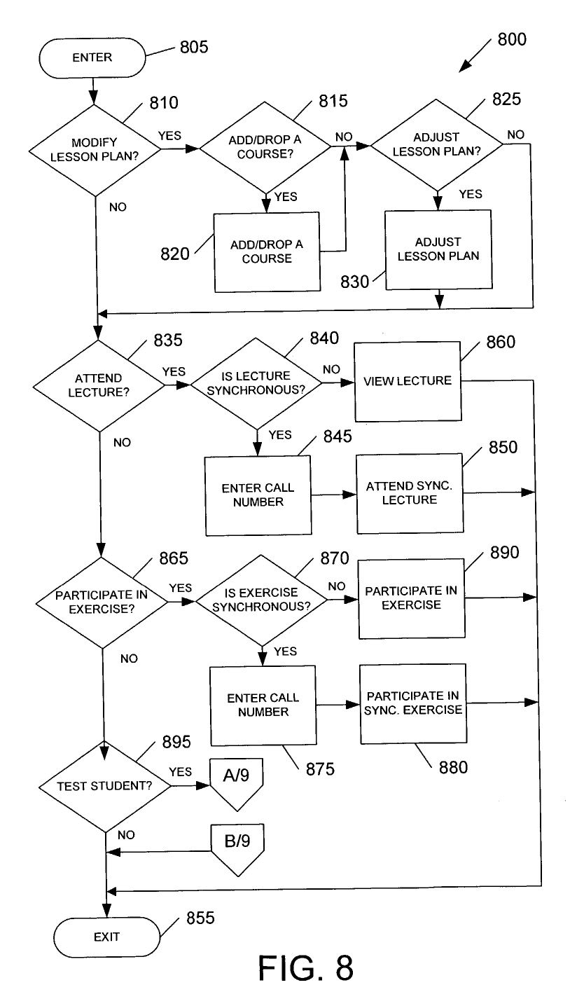

FIG. 8 is a flow diagram showing a detailed embodiment of a method of the present invention for using a customized lesson plan;

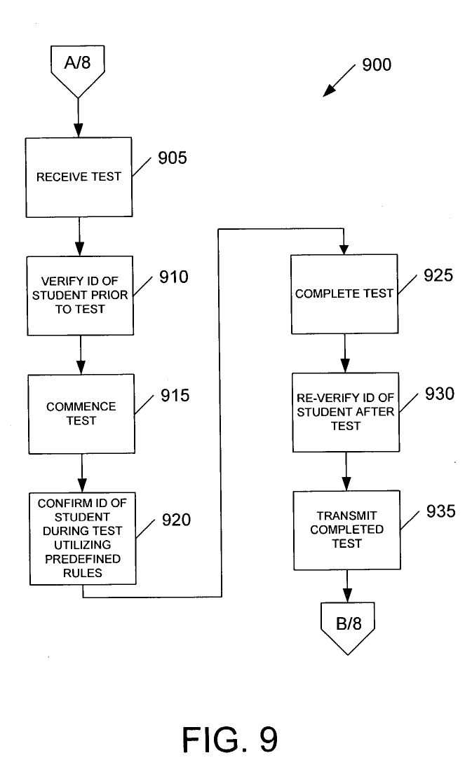

FIG. 9 is a flow diagram showing a detailed embodiment of a method of the present invention for administering a test to a student taking a distance learning class, aspects of which may be used to ensure the identity of a student when communicating with a counselor over an electronic network;

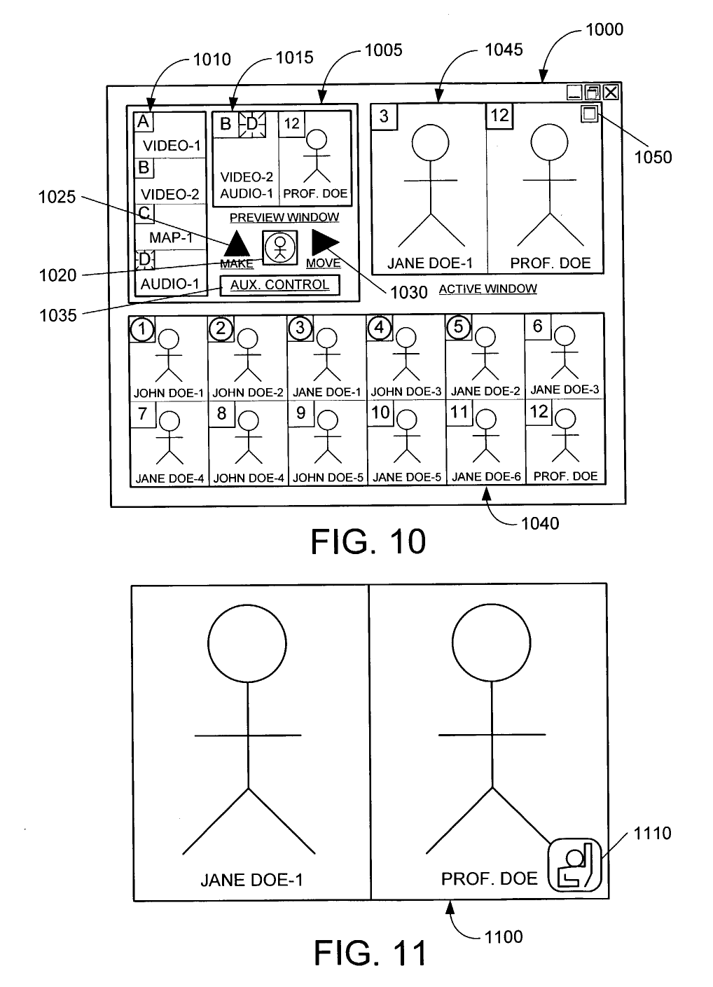

FIG. 10 is an exemplary screenshot of a presentation control screen that enables an instructor to configure the presentation of image and/or audio data on one or more client computers of students attending a distance learning class;

FIG. 11 is an exemplary screenshot of a presentation screen that was configured by an instructor using a presentation control system; and

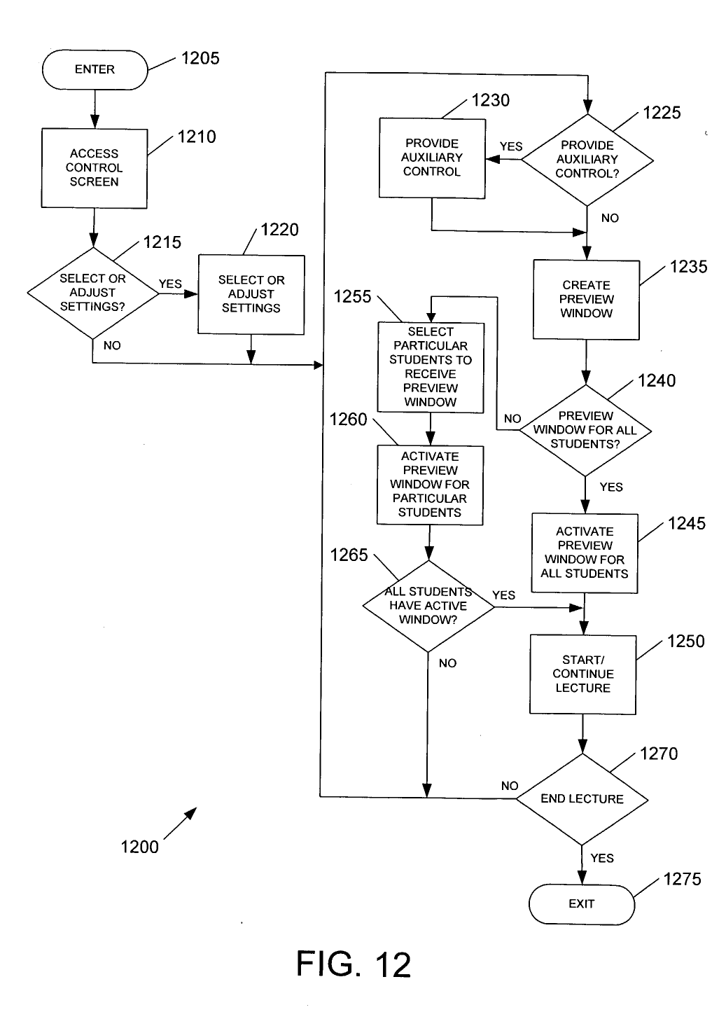

FIG. 12 is a flow diagram showing a detailed embodiment of a method of the present invention for using the presentation control system.

In the figures, off-page references are used to refer the reader to figures that continue on another drawing page. The references include two parts: an off-page reference letter and a figure number in which the figure continues or from which the figure is continued. An example of an off-page reference is “A/9”, where “A” is the off-page reference letter and “9” is the figure number on which the figure continues or from which the figure is continued.

### DETAILED DESCRIPTION OF THE PREFERRED EMBODIMENTS

The present invention provides a system and method that may be used to generate a customized lesson plan for students that intend to take distance learning courses. The customized lesson plan may be based on the student's demographic profile, academic records, educational goal, and courses available from one or more course content providers. In addition, the present invention provides a system and method that enables an instructor to control a presentation of image and/or audio data on client computers of students attending a distance learning class, thereby providing improved communications between the instructor and the students. Furthermore, the present invention provides a system and method to verify the identity of a student while the student takes a test during a distance learning class or while the student receives counseling. Verifying the student's identity during testing or counseling ensures that the student in fact takes the test or receives proper counseling, respectively, and instills confidence in the distance learning system.

Embodiments of the disclosed educational system and method are both novel and profound. Students for the first time—regardless of the type of school, economic/social strata, or geographic location/isolation—will be able to experience an individualized presentation and processing of their academic experience. Furthermore, classic impediments to a student's education including, for example, “sick days,” “snow days,” security concerns, language barriers, physical challenges, and religious/ethnic beliefs will no longer interfere with their educational progress.

FIG. 1 is a block diagram of an embodiment of a computer system 100 of the present invention. The computer system 100 includes a server 105, which may be, for example, the server of a distance learning company that provides distance learning services, a course provider such as an instructor or learning institution, or a host for providing server services to a distance learning company or course content provider.

The server includes a storage medium 110 that may be any type of storage device as are well know in the art including without limitation, for example, a floppy disc, optical disc, DVD, CD-ROM, magnetic optical disc, RAM, EPROM, EEPROM, magnetic or optical card, or any other type of storage media that is, or in the future found to be, suitable for storing electronic instructions/data. The storage medium 110 contains various data bases, programs, and web pages for implementing the present invention including, for example: student profiles 112; student academic records 114; courses available (course content) for distance learning 116; rule sets for developing a lesson plan 120; lesson plan development files, programs and web pages 122; and lesson plan implementation files, programs, and web pages 124. The server 105 may be in communication with other servers 140-150 (representing one or more servers) via a network 130 such as an organization's intranet or the Internet. The servers 140-150 may provide data bases, programs, and web pages as disclosed above and/or additional data bases, programs, and web pages for implementing the present invention.

The computer system 100 further includes client computers 160-170 (representing one or more client computers) in communication with the server 105 via the network 130. The servers 105, and 140-150, and client computers 160-170 may be configured as the general purpose computer 200 shown in FIG. 2 and described herein below. As will be described in more detail herein below, instructors, counselors, IEP Team members, students, etc. may utilize the client computers to communicate with the servers and with each other in accordance with embodiments of the present invention.

The present invention may be implemented utilizing existing server engines such as the Symbiosis™ server engine by Individual Network®, LLC (West Palm Beach, Fla.). The Symbiosis™ engine, aspects of which are disclosed in U.S. Pat. No. 6,434,747 to Khoo, et al., the contents of which are incorporated by reference herein, and may be implemented in a number of ways including Internet-based television, digital cable, or analog systems.

FIG. 2 illustrates a high-level block diagram of a general purpose computer 200 which may be used to implement the present invention. The general purpose computer may act as server computers 105, and 140-150 or client computers 160-170 shown in FIG. 1. The general purpose computer 200 includes a processor 210 and memory 215. Processor 210 may contain a single microprocessor or a plurality of microprocessors for configuring the computer system as a multi-processor system. Memory 215 stores instructions and data for execution by processor 210. If the system of the present invention is wholly or partially implemented in software, including computer instructions, memory 215 stores the executable code when in operation. Memory 215 may include banks of dynamic random access memory (DRAM) as well as high speed cache memory.

The computer system 200 may further include one or more mass storage devices 220, peripheral devices 225, audio devices 230, input devices 235, portable storage-medium drives 240, graphics subsystems 245, and display devices 250. For purposes of simplicity, the components shown in FIG. 2 are depicted as being connected via a single bus 255, however, the components may be connected through a network. For example, processor 210 and memory 215 may be connected via a local microprocessor bus, and the mass storage device 220, peripheral device 225, portable storage medium drive 240, and graphics subsystem 245 may be connected via one or more input/output (I/O) buses. Mass storage device 220, which is typically implemented with a magnetic disk drive or an optical disk drive, may be a non-volatile storage device for storing data and instructions for use by processor 210. The mass storage device 220 includes the storage medium of embodiments of the present invention, and the server storage medium and client storage medium in alternative embodiments.

Portable storage medium drive 240 operates in conjunction with a portable non-volatile storage medium, such as a floppy disk, or other computer-readable medium, to input and output data and code to and from the computer system 200. In one embodiment, the method of the present invention that is implemented using computer instructions is stored on such a portable medium, and is input to the computer system 200 via the portable storage medium drive 240. Peripheral device 225 may include any type of computer support device, such as an input/output (I/O) interface, to add additional functionality to the computer system. For example, peripheral device 225 may include a network interface card for interfacing computer system 200 to a network, a modem, and the like.

Input device 235 provides a portion of a user interface. Input device 235 may include an alpha-numeric keypad for inputting alpha-numeric and other key information, or a pointing device, such as a mouse, a trackball, stylus or cursor direction keys. In order to display textual and graphical information, the computer 200 includes graphics subsystem 245 and a display device 250. Display device 250 may include a cathode ray tube (CRT) display, liquid crystal display (LCD), plasma display, other suitable display devices, or means for displaying. Graphics subsystem 245 receives textual and graphical information and processes the information for output to display device 250. The method of the present invention may be directly and practically implemented through the use of the display device 250. In one embodiment, an audio device 230 includes a sound card that receives audio signals from a microphone that may be found in a peripheral device 225. In another embodiment, the audio device 230 may be a processor, such as processor 210, that processes sound. Additionally, computer system 200 includes output device 260. Examples of suitable output devices 260 include speakers, printers, and the like.

The computer system 200 may also include one or more biometric detectors 265 or behavioral characteristic monitors to implement an embodiment of the present invention. Biometric detectors 265 may be used to implement automated methods for recognizing a person based on one or more physiological or behavioral characteristics. Examples of physiological characteristics that are measured include, for example, a person's face, fingerprints, a hand geometry, handwriting, an iris, a retina, hand veins, and a person's voice. Examples of behavioral characteristics that may be measured include the characteristics of a person's keyboard typing dynamics and signature dynamics.

The devices contained in the computer system 200 are those typically found in a general purpose computer and it is intended that the computer system 200 may comprise a broad category of such computer components that are well known in the art. The computer system 200 illustrates one platform which can be used for implementing the method of the present invention. Numerous other platforms may also suffice, such as Macintosh-based platforms available from Apple Computer, Inc. (Cupertino, Calif.), platforms with different bus configurations, networked platforms, multi-processor platforms, other personal computers, workstations, mainframes, navigation systems, and the like.

In order to fully benefit from distance learning, distance learners need to be able to readily access courses that satisfy their educational goals. As with most endeavors to achieve a goal, getting started is half of the battle. In the case of acquiring an education—especially in the distance learning environment—establishing a viable curriculum that will enable a student to achieve his educational goals is especially arduous. The present invention empowers individuals to reach their goals by providing a convenient, economical, and targeted system and method to develop a lesson plan.

Referring to FIG. 3, an exemplary lesson plan 300 is shown that was developed utilizing a system and method of the present invention. For convenience, the term “lesson plan” as used herein is intended to refer to either the lesson plan of an entire curriculum that satisfies an educational goal of a user, or to refer to a portion thereof (e.g., the “lesson plan” shown in FIG. 3, which covers only a first semester of a multi-semester “lesson plan”).

The lesson plan 300 covers sixteen weeks of a first semester and has categories of information concerning each course of study including course ID, course description, class day and date, class time, class type and sequence number, and an indication as to whether or not a class is synchronous. A lesson plan may include courses of study for an entire curriculum or for a portion of a curriculum and may extend over various periods of time. The exemplary lesson plan 300 includes a portion of a curriculum (e.g., courses toward a bachelor's degree in engineering) and extends for a semester (e.g., Spring 2003). A lesson plan may be updated from time to time to reflect a student's progress. In the example provided, the lesson plan 300 includes classes made up of lectures, exercises, and tests. Lectures, exercises, and tests may be synchronous, that is, attended at the same time by other students and an instructor, or asynchronous.

Classes identified in a lesson plan may be linked to source material. For example, a student may click on an icon associated with “Lecture-1” of Math-101, which is linked to source material stored on a server, to cause a video of Lecture-1 to stream to his client computer. Similarly, a student may click on an icon associated with “Lecture-1” of Phys-101, which may be linked to an instructor who is to lecture during the synchronous class, to connect the student to the instructor's client computer.

The system and method allows a student to modify their lesson plan as permitted by predetermined rules. This provides flexibility for distance learners. For example, a distance learner having lesson plan 300 may move Lecture-1 for Math-101 to another day and time to facilitate a change in his work schedule. Predetermined rules may, however, prevent the student from moving Lecture-1 to a date too close to or after Lecture-2 for Math-101 in order to ensure the student has sufficient time between classes to absorb the material and prepare any assignments, and ensure the classes are taken in the correct order (e.g., Lecture-2 will typically build on Lecture-1). Likewise, moving a class may not be permitted if the class is synchronous. Furthermore, a student may add or remove a course from the lesson plan according to predetermined rules. For example, the student may remove Phys-101 from the lesson plan because he must work every Tuesday and the Tuesday classes cannot be moved to another day/time (e.g., the predetermined rules disallow moving the class because it is a synchronous class).

FIG. 4 is a block diagram 400 of the flow of information that may be used to develop a student's customized lesson plan. Generally, three types of information are utilized: (a) student information; (b) course provider information; and (c) other information.

Student information may include, for example, a student's personal profile, academic record, and educational goal. The student's personal profile may include information such as his age, languages spoken, and/or working schedule. The student's academic record may include information such as: the results from a learning difference evaluation; scores from a WISK test, NEDT, GED, SAT, MCAT, and/or LSAT; transcripts from pre-kindergarten, kindergarten, primary school, high school, college and/or graduate/professional school; and/or the grades received for courses completed following previously-developed lesson plans. The student's educational goal may include taking course work in modern art studies, receiving a certificate in automobile repair, taking courses in preparation for taking the Engineer-In-Training examination, receiving a bachelor's degree in software engineering, and/or meeting the educational objectives of an IEP. Course provider information may include: an instructor's or a course provider's list of available courses; descriptions of the available courses; and/or a rule set.

Other information may be utilized to develop a student's customized lesson plan including, for example: an instructor's critique or recommendation of a student's past performance in a previously attended course; historical use of previously developed lesson plans; and/or a list of courses and recommendations as outlined in a disabled student's IEP. The basic criteria for any information that may be used to develop a customized lesson plan is that it facilitates the development of a plan that will lead a student toward attaining his/her educational goal.

For the purpose of this description the term “course provider” is intended to be defined broadly to include, but not limited to, a person or organization of any kind, such as an “instructor” or “learning institution,” that may provide courses for use in a customized lesson plan. The term “instructor” is intended to be interpreted broadly to include, but not limited to, teachers, teaching assistants, professors, counselors, tutors, mentors, coaches, and IEP Team members. The term “learning institution” is intended to be defined broadly to include, but not limited to, pre-kindergartens, kindergartens, primary schools, high schools, colleges, graduate/professional schools, technical schools, corporate in-house training centers, and other educational centers such as the implementers of the present invention.

Each lesson plan that is developed utilizing the system and method of the present invention will be tailored to each student for whom a plan is made. For example, if a student indicates that he reads/speaks only the Spanish language and that he has developed an expertise in basic mathematics, the student may receive a lesson plan that includes a chemistry course (e.g., in video form) taught in the Spanish language but does not emphasize the basics of mathematics. Furthermore, the chemistry course may be tailored to meet the particular requirements of the student's anticipated career. For example, the chemistry course may emphasize different chemistry topics to a student whose goal is to become a metallurgist versus a student whose goal is to become a bench chemist. A lesson plan may also be affected by the requirements of the course provider whose courses make up the curriculum. For example, College A may have a particular approach to teaching its general chemistry course in order to prepare its students to take a standardized test, while College B may not have the same approach to teaching its general chemistry course since its students are not required to take the same standardized test. Customized lesson plans may also be developed for specialization skills. For example, a student may desire to become a draftsman of mechanical devices. If the student's profile shows that the student lacks a basic understanding of geometric tolerancing then his lesson plan may include courses that teach the basic concepts behind that system of tolerancing. Further, a blind student may receive a lesson plan that includes a course teaching how to navigate mass transit in a city in which she anticipates working or a course teaching how to run a business from a home office.

The present invention may also be used to create lesson plans that supplement educational programs for the disabled. For example, the Individuals with Disabilities Education Act (“IDEA”) mandates that all children with disabilities must be provided with a free and appropriate education. The six principles that provide a framework for such special educational services are: (1) a free and appropriate public education (“FAPE”) must be provided for all students, regardless of disability; (2) each student should be given an appropriate evaluation to determine his or her abilities and needs; (3) each student should have an Individualized Educational Program (“IEP”) that is designed specifically to meet his or her needs; (4) each student should receive an education in the least restrictive environment; (5) parents and students should participate in all decisions that are made regarding the student's education; and (6) procedural safeguards (as identified by IDEA) should be followed to ensure that each student's rights under the law are protected.

A central tool to implement the principles the IDEA is the IEP, which specifically spells out the accommodations that will best suit the needs of a child. Each IEP must have particular information including: a child's present level of educational performance; how the child's disability affects his or her involvement and progress in the regular curriculum; measurable goals that include identifiable short-term and long-term objectives; how progress reports on those goals will be made and how parents will be kept informed of the child's progress; special education, related services and supplementary aids and services that are to be provided to, or on behalf of, the child; program modifications or school personnel support that will be provided to ensure that the child will advance appropriately toward his or her annual goals; any individual modifications to be made in the administration of state and district-wide assessment programs of student achievement and how the student would be assessed to accommodate his or her disability and still meet the mandate of the state or district; a reasonable date for the beginning of services and modifications and the anticipated frequency, location and duration of services and modifications; and a component on the transitions planned for the child, beginning at age 14.

The IEP is developed and maintained by an IEP Team, which includes: the parents of the child; at least one teacher of the child (if the child is participating in the regular classroom); at least one special education teacher or service provider; a representative of the local education agency who is qualified to provide specially designed instruction to meet the needs of children with disabilities and who is knowledgeable about the general curriculum and about the availability of resources for students with disabilities; an individual who can interpret the instructional implication of evaluation results; other individuals who have knowledge or special expertise regarding the child; and the student, when appropriate.

Use of the present invention to support and facilitate educational programs for the disabled, for example, to support and facilitate IEPs developed under the IDEA, is described in more detail herein below.

FIG. 5 is a flow diagram 500 showing generally an embodiment of a method of the present invention for creating a customized lesson plan. At step 510, student information is received by a system configured in accordance with the present invention including, for example, the student's personal profile, academic record, and the student's educational goal. At step 520, information from one or more course providers is received by the system including, for example, a list of available courses, descriptions of the available courses, a rule set, and recommendations and/or critiques of the student's performance. At step 530, a lesson plan customized for the student is determined based on the information received from the student and the one or more course providers.

FIG. 6 is a flow diagram 600 showing a detailed embodiment of a method of the present invention for creating a customized lesson plan. It is notable that the system and method may be configured to be activated and navigated by disabled users. For example, the system may be configured so that disabled students may interact with the system by audible means (e.g., using JAWS® for Windows® by Freedom Scientific, Inc., St. Petersburg, Fla.), and/or Braille systems (e.g., using ALVA Satellite 544 refreshable Braille displays by ALVA Access Group, Inc., Oakland, Calif.), and/or communication methods for the hearing impaired including sign language. Utilizing such tools makes the system available to a wider audience including disabled students that are unable to use a standard computing system.

At step 605 a user enters a web site that is configured in accordance with the system and method of the present invention. At step 610, the user is prompted to identify one or more course providers from which he desires to take distance learning courses. If the user has a preference as to which course provider is to provide the courses then the user proceeds to step 615 and enters the names of the course providers. Thereafter the user proceeds to step 620. If, at 610, the user does not have a preference as to which course providers are to provide the distance learning courses then the user proceeds directly to step 620. In such case the system may select course providers from which course provider information can be obtained.

At step 620 the user is prompted as to whether the user desires to input profile data. If the user does desire to input profile data the user may proceed to step 625 and enter various profile data as described above. Thereafter, the user proceeds to step 630. If, at step 620, the user does not desire to enter profile data then he proceeds directly to step 630.

At step 630 the user is prompted as to whether the user desires to input/import his academic records. If the user does desire to input/import the user's academic records then the user proceeds to step 635 and inputs/imports the user's academic records. Thereafter, the user proceeds to step 637. If, at step 630, the user does not desire to input/import the user's academic records then the user proceeds directly to step 637.

At step 637 the user is prompted as to whether the user desires to input other information. If the user does desire to input other information then the user proceeds to step 639 and inputs other information including, for example, an instructor's recommendation or critique of a student's past performance in one or more previously attended courses, or a list of courses and/or recommendations as outlined in an IEP. Thereafter, the user proceeds to step 640. If, at step 637, the user does not desire to input other information, then the user proceeds directly to step 640.

At step 640 the user enters the user's goals. Examples of such goals include, but are not limited to, a goal to take course work in modern art, obtain a certificate in automotive repair, prepare for the Engineer-In-Training examination, receive a bachelor's degree in software engineering, or meet the educational objectives of an IEP. Thereafter the user proceeds to step 645.

At step 645 the user is prompted as to whether the user desires to be tested in an effort to determine if the user requires remedial classes in a particular subject or has gained sufficient knowledge from his life experience so that the he may receive credits (e.g., coursework credits) in a subject toward the user's desired goal. For example, if the user indicated that the user is interested in engineering then through testing the user may find that he will require remedial trigonometry classes (because he forgot or never took such courses in high school) or should receive coursework credits for physics-I (because he learned about basic AC and DC circuits while working several years as an electronics designer). As a further example, testing may include state or district-wide assessment tests to facilitate the development of or implement aspects of a disabled student's IEP. The results of such testing will be used in an analysis to determine a customized lesson plan for the user. If testing is desired, then the user proceeds to step 650 and he is tested. Thereafter, the user proceeds to step 655. If, at step 645, the user does not desire to be tested then he proceeds directly to step 655.

At step 655 the system determines a customized lesson plan for the user. The system applies a rule set to make its determination. The rule set may include rules from one or more course providers selected by the user or rules devised by, for example, administrators of a system configured in accordance with a system and method of the present invention. Factors that may affect a rule set include curriculum accreditation requirements, scheduling requirements, and course availability. Exemplary rules in a rule set include the following: courses that are to be included in a lesson plan must lead toward satisfying the goal requirement of the student (an example of a curriculum-building rule); credit for a previously taken course can be received only if the course was taken within the past two years (an example of a course time-bar rule); students must have a GPA in prerequisite coursework greater than 3.5 (on a 0.0-4.0 scale) to take advanced course work (an example of a GPA threshold rule); students must take Math-I before they take Math-II (an example of a course prerequisite rule); students cannot take History-I held on Monday at 9:00 A.M. and Math-I held on Monday at 9:00 A.M. (an example of,a course/course conflict rule); courses that are to be included in a lesson plan must not interfere with the student's work schedule (an example of a work/course conflict rule).

Once a customized lesson plan is determined it is transmitted to the user for his review at step 660. An example of a lesson plan for a first semester of a multi-semester curriculum is illustrated in FIG. 2. The lesson plan provided to the user may cover the entire curriculum for the user, thereby allowing the user to review all of the courses of study he is required to take to achieve his goal. Furthermore, although the lesson plan illustrated in FIG. 2 is described as being divided into a semester of classes, the lesson plan may just as well be segmented into any convenient division of study (e.g., trimester or other convenient division). Upon reviewing the lesson plan the user may decide that he wants to make adjustments to the plan (e.g., move an asynchronous lecture to a different date and/or time, select a comparable course, take more or less courses). After the user has reviewed the lesson plan he proceeds to step 670.

At step 670 the user is prompted to submit the lesson plan to an instructor for review. If the user desires an instructor (e.g., a teacher, advisor, mentor, IEP Team member) to review the lesson plan then, at step 675, the lesson plan is transmitted to the instructor and the instructor reviews the lesson plan. At step 680 the instructor revises the lesson plan as the instructor deems necessary in order to better align the lesson plan with the goal of the user. Thereafter, the revised lesson plan is transmitted to the user at step 660 for his review. If, at step 670, the user does not desire for an instructor to review the lesson plan then he proceeds directly to step 685.

At step 685 the user is prompted as to whether the lesson plan is acceptable. If the lesson plan is not acceptable to the user then he proceeds to step 687. At step 687 the user is prompted as to whether he desires to revise the inputted data. If the user desires to revise the inputted data then the system proceeds to step 610 and proceeds as described above. If, at step 687, the user does not desire to revise the inputted data but instead desires to delete the unacceptable lesson plan then the user proceeds to step 693, deletes the unacceptable lesson plan, and exits the system at step 695. If, at step 685, the user desires to accept the lesson plan then he may proceed to step 690 where the lesson plan is stored and made available to the user for execution.

The user then proceeds to step 694 where he may submit the lesson plan to course providers so they may bid on supplying one or more courses in the lesson plan. The system may submit courses individually or as a group to course providers. The advantage of submitting courses as a group is that course providers may then be able to provide the courses at more competitive prices. Thereafter, the user may proceed to step 695 where he exits the system.

It is notable that the system may be set up so that a course provider can compensate the system administrator (e.g., the implementator of the present invention) for accepting the course provider's bid. For example, a group of students seeking to take a general chemistry course could be proffered by the system to a number of course providers so they may bid on providing the course. The course provider that offers to provide the course on the most economically favorable terms would receive a contract to provide the course to the group of students. Part of the fees for providing the course could be proffered to the system administrator for initially allowing the course provider to bid on providing the course.

It should be apparent that the system of the present invention also encompasses the idea that distance learning students may reach their goal (e.g., receive a bachelor's degree) based on courses of study provided by numerous course providers. Each curriculum should, if deemed necessary, be accredited by an appropriate accreditation agency.

FIG. 7 is a flow diagram 700 showing generally an embodiment of a method of the present invention for using a customized lesson plan. At step 710 a user selects a lecture to attend, an exercise to participate in, or a test to take, depending on the requirements of the lesson plan. At step 720 the user attends the selected class and fulfils the requirement of the class (e.g., views a lecture, participates in an exercise, takes a test). At step 730, if it is a requirement of the class, the user transmits a completed assignment, exercise or test.

FIG. 8 is a flow diagram 800 showing a detailed embodiment of a method of the present invention for using a customized lesson plan. The system and method may be activated and navigated with any number of input devices including, for example, voice prompts. At step 805 a student enters a web site that is configured for attending distance learning classes and, at step 810, is provided the option to modify his lesson plan. The lesson plan may have the form of the lesson plan illustrated in FIG. 3. If the student desires to modify the lesson plan then the student proceeds to step 815.

At step 815 the student is prompted to add and/or drop a course. During the process of adding and/or dropping a course the system may allow or require one or more steps described above with respect to FIG. 6. For example, the student may be required to have an instructor review the revised lesson plan to ensure that it continues to fulfill the student's desired goal. If the student desires to add and/or drop a course then he proceeds to step 820 and, after adding and/or dropping a course, proceeds to step 825. If, at step 815, the student does not desire to add and/or drop a course then he proceeds directly to step 825.

At step 825 the student is prompted to adjust the course scheduling in the lesson plan. If the student desires to adjust the lesson plan then he will proceed to step 830 and adjust the lesson plan. Having the option to adjust the course scheduling of a lesson plan throughout the learning period (e.g., semester, trimester) is a significant convenience for a student. It is notable, however, that course scheduling rules may limit the degree to which the lesson plan is adjusted. For example, the scheduling rules would likely permit a student to reschedule Lecture-1 of Math-101 from Monday Jan. 27, 2003 to Thursday Jan. 30, 2003, however, the scheduling rules would likely prevent a student from rescheduling Lecture-1 of Math-101 from Monday Jan. 27, 2003 to Tuesday Feb. 4, 2003 for two reasons: first, such an adjustment would cause Lecture-1 of Math-101 to occur after Lecture-2 of Math-101; and second, Lecture-1 of Math-101 would then conflict with Lecture-2 of Phys-101. From the example it should be apparent that a rule set for developing a lesson plan may include course scheduling rules.

After the student adjusts the lesson plan he may proceed to step 835. If, at step 825, the student does not desire to adjust the lesson plan then the student may proceed directly to step 835. If, at step 810, the student does not desire to modify the lesson plan then the student may proceed directly to step 835.

At step 835 the student reviews the lesson plan to determine whether he is scheduled to attend a lecture. A signal may also be provided to remind the student that a lecture is scheduled. If a lecture is scheduled for that day and time and it is determined at step 840 that the lecture is synchronous, then the student may proceed to step 845 to enter a call number (or logon ID) to access the lecture and, at step 850, attend and participate in the synchronous lecture. A system and method directed to attending synchronous lectures is described in more detail herein below. Thereafter, the student may proceed to step 855 to exit the web site. If, at step 840, it is determined that the lesson is asynchronous then the student may proceed to step 860 and view a video of the lesson. Thereafter, the student may proceed to step 855 to exit the web site. Whether a class is synchronous or not may be indicated in the lesson plan as illustrated in FIG. 3, the last column to the right. In the exemplary lesson plan, only the physics class (Phys-101) is a synchronous class. If, at step 835, the student is not scheduled to attend a lecture then the student proceeds directly to step 865.

At step 865 the student reviews the lesson plan to determine if he is scheduled to participate in an exercise. A signal may also be provided to remind the student that an exercise is scheduled. If an exercise is scheduled for that day and time and it is determined at step 870 that the exercise is synchronous, then the student may proceed to step 875 to enter a call number (or logon ID) to access the exercise and, at step 880, participate in the synchronous exercise. The system and method described below for attending synchronous lectures may also be used for participating in synchronous exercises. Thereafter, the student may transmit any completed assignments and/or exercises to the instructor and proceed to step 855 to exit the web site. If, at step 870, it is determined that the exercise is asynchronous then the student may proceed to step 890 and participate in an exercise on his own. Thereafter, the student may transmit any completed assignments and/or exercises to the instructor and proceed to step 855 to exit the web site. If, at step 865, the student is not scheduled to participate in an exercise then the student proceeds directly to step 895.

At step 895 the student reviews the lesson plan to determine if he is scheduled to take a test (of course a “pop quiz” can be scheduled without it showing up in the student's lesson plan). A signal may also be provided to remind the student that a test is scheduled. Referring to FIG. 9, a flow diagram is shown that details an embodiment of a method of the present invention for administering a test to a student taking a distance learning class. If a test is scheduled for that day and time then the student may select and receive the test at step 905. During testing it is imperative that the identification of the student is verified to ensure that he is, in fact, the person he says he is (i.e., that someone else is not attempting to take the test for him). In order to verify the identification of the student, one or more physical characteristics of the student may be measured including, for example, the student's face, fingerprints, a hand geometry, handwriting, an iris, a retina, hand veins, and the student's voice. Those skilled in the art will appreciate that biometric-based authentication devices are available for obtaining such measurements.

At step 910 a biometric authentication device records a physical characteristic of the student. Data representative of the physical characteristic of the student is transmitted to a server (e.g., server 105 of FIG. 1) for verification. At the server, the data is compared to a database of data representative of the physical characteristic of a number of students. If there is a match between the data transmitted by the student and the data in the database, then the identification of the student may be verified. Multiple identification methods may be used to further verify the identity of a student. At step 915, the student commences taking the test.

At step 920, the system confirms the identification of the student during the test utilizing predefined rules. More particularly, once the identification of the student has been verified, his identification may be confirmed throughout the testing period by continually tracking him. This will ensure that the student does not initially have his identity verified and then have someone else sit in for him to take the test. Tracking may be performed by obtaining a continuous stream of confirmation data of the student commencing at a time about when data of the physical characteristic of the student is obtained to a time about when the student completes and transmits the test to the server. The confirmation data may be, for example, biometric, video, and/or audio data. The confirmation data may be taken at various sample rates. For example, video data may be taken at a sample rate of about 30 frames/second, 1 frame/second, or 1 frame/3 seconds. The use of lower sample rates would reduce the amount of data that must be transmitted to the server. Further efficiencies may be accomplished by utilizing data compression techniques.

After confirmation data is transmitted to the server it is analyzed in accordance with one or more predefined rules. An example of such an analysis and application of a predefined rule follows. Upon receipt of the video data, the server may select a region-of-interest in the video data (e.g., a region of each frame of the video data where the chest of a student would likely be positioned), periodically calculate the average gray-scale value of the region, and compare the average gray-scale value to an acceptable high grayscale value and an acceptable low grayscale value. If the average gray-scale value deviates above or below the acceptable high or low grayscale values, respectively, then the system may transmit a signal to the student's client computer to cause the test to be discontinued until the identity of the student can be re-verified. The method would prevent the student from leaving the client computer after verification of a physical characteristic in order to allow another person to take the test for him. Those of ordinary skill in the art will appreciate that other analysis methods and rules may be utilized to ensure a student does not allow another person to take a test for him.

At step 925 the student completes the test at which time the system may discontinue tracking him. At step 930 the student may be required to re-verify his identity by having one or more physical characteristics of the person measured and transmitted to the server. Thereafter, at step 935, the student transmits the completed test to the server and, at step 855 (FIG. 8), he exits the web site. If, at step 895, the student is not scheduled to take a test then the student may proceed directly to step 855 to exit the web site.

Those skilled in the art will appreciate that the present invention for ensuring the identity of a student taking a test in a distance learning class may be used in a more general sense to ensure the identity of a first person when communicating with a second person (e.g., to ensure the identity of a student, instructor, etc. during any privileged communication in the educational support process). Further, when circumstances warrant it, the invention may be used to ensure the identity of the second person when communicating with the first person. Ensuring a person's identity during such two-way communications is particularly useful when the first person and second person are having a privileged communication. Relationships that may have such privileged communications include, but are not limited to, counselor/student (or a counselor with a legal representative of a student), doctor/patient, psychologist/patient, attorney/client, attorney/attorney, attorney/agent, husband/wife, parent/teacher, minister/penitent, government agent/non-government agent, and detective/client relationships.

As an example, the method may be used during communications between a counselor and a student. The counselor may be, for example, an instructor, tutor, psychiatrist, or psychologist. The method may include the steps of initiating a communication between the counselor and the student; receiving a first set of data representative of a physical characteristic of the student; comparing the first set of data to a second set of data representative of the physical characteristic of the student to verify the identity of the student; receiving a continuous stream of confirmation data of the student that begins at a time about when the first set of data was created and ends at a time about when the communication between the counselor and student is terminated; and analyzing the continuous stream of confirmation data to ensure the confirmation data satisfies predefined rules.

In an embodiment of the method for ensuring the identity of a student during counseling, the step of initiating a communication between a counselor and a student may be in response to the counselor or the student sending an electronic message to the other of the counselor and the student. The method may also include the step of transmitting a signal to the counselor that confirms the identity of the student during counseling.

Referring to FIGS. 10-12, a presentation control system is disclosed for providing an instructor control over what is displayed and heard on client computers of students attending a synchronous course of instruction. The system and method may be used in conjunction with the system and method for developing and using a lesson plan as described herein-above. In addition, the presentation control system may be used between and among instructors and students during attendance of classes, during class recesses, or after scheduled classes.

With the presentation control system the instructor may be located, for example: at a learning institution delivering a lesson to students that attend via client computers from their own homes; in a conventional classroom delivering a lesson to students attending the lesson in person while other students attend via client computers from their own homes (e.g., disabled students attending the lesson at home in accordance a lesson plan based on their respective IEPs); or at a remote site delivering a lesson to students that attend the lesson in a conventional classroom via a client computer (e.g., using a large format display and a video camera focused on the entire class) while other students attend via client computers from their own homes.

Using the presentation controls an instructor may, for example, control the view of each student, the configuration, the sequencing, and the timing of images and audio to students. In a sense, the instructor functions as a television producer who sits at a master control and interacts with a dynamic and open system. More particularly, the instructor may enable one or more students to see and/or hear one or more other students, the instructor only, a video presentation, an audio presentation, or any combination thereof.

For the description of the presentation control system, the term “presentation control screen,” or variants thereof, may be defined as a screen projected on a monitor of an instructor's and/or assistant's client computer used for controlling how, what, and when images and/or audio are presented on client computers of students attending a synchronous distance learning class. The term “presentation configuration,” or variants thereof, may be defined as a configuration (or organization) of image and/or audio data as seen and heard by a student on a client computer. The term “presentation control data,” or variants thereof, may be defined as data controlling a presentation configuration. The term “presentation screen,” or variants thereof, may be defined as a screen projected on the monitor of a client computer that is viewed by a student, the projected screen having the presentation configuration as created by an instructor or auxiliary user. And the term “image and/or audio data,” or variants thereof, may be defined as data that is transmitted to one or more client computers for viewing by a student on a client computer. The data is displayed on the one or more client computers in accordance with a presentation configuration created by an instructor or an auxiliary user and may include streaming data as when the presentation configuration includes images and sounds of an instructor as he teaches a lesson, or blocks of data as when the presentation configuration includes still images.

Referring to FIG. 10 there is shown an exemplary screenshot of a presentation control screen 1000 for enabling an instructor to configure the presentation of images and/or audio data on one or more client computers of students attending a distance learning class. The presentation controls may include a configuration panel 1005, an active window 1045, and an attendee window 1040.

The configuration panel 1005 includes an image/audio selection window 1010, a preview window 1015, a student selection button 1020, a preview window “make” button 1025, a preview window “move” button 1030, and an auxiliary control (“aux. control”) selection button 1035. The controls in the configuration panel 1005 are generally used to configure the presentation of image and/or audio data on one or more client computers of students.

The attendee window 1040 may display the image of each student attending the distance learning class and the instructor of the class (identified by reference nos. 1-12). In the example, eleven students are attending a class (John Doe-1 through John Doe-5 and Jane Doe-1 through Jane Doe-6 (reference nos. 1-11)) and the instructor (Prof. Doe (reference no. 12)) is leading the class. The circles around reference nos. 1-5 indicate that those particular students are receiving the presentation as shown in the active window 1045. By clicking on the student selection button 1020 the active window 1045 changes to a second presentation configuration (not shown), the circles around reference nos. 1-5 disappear, and circles around the reference nos. 6-11 appear to indicate that those particular students are receiving the images and/or audio data in conformance with the second presentation configuration. Although the present example describes eleven students, five of which (reference nos. 1-5) are receiving images and/or audio data in conformance with the presentation configuration shown in active window 1045 and six of which (reference nos. 6-11) are receiving image and/or audio data in conformance with a second presentation configuration, those skilled in the art will appreciate that more or less students may be included in a distance learning class and any number of presentation configurations may be created to present image and/or audio to the class of students.

An instructor may create a presentation configuration in the manner described below. Initially, the instructor may add shortcuts to instructional materials that he desires to present during a class. In the exemplary presentation control screen 1000 the instructor added shortcuts “A” (Video-1), “B” (Video-2), “C” (Map-1), and “D” (Audio-1) to the image/audio selection window 1010 of configuration panel 1005. The instructor then created the presentation configuration in the preview window 1015 of the configuration panel 1005. This was done by clicking on the preview window “make” button 1025 to activate the preview window 1015 and then clicking on and dragging the components needed to make up the desired presentation configuration into the preview window 1015. In the exemplary presentation control screen 1000 the instructor created a presentation configuration in preview window 1015 having shortcuts “B” (Video-2) and “D” (Audio-1) on the left-hand side of the preview window 1015 and the image of the instructor (reference no. 12) on the right-hand side of the preview window 1015. Assuming the instructor desires for all of the students to receive the images and audio data as configured in the preview window 1015, the instructor will then click on the student selection button 1020 and click on all of the students in the attendee window 1040. Once the presentation configuration in preview window 1015 is completed and the students are selected, the instructor again clicks on the “make” button 1025 to deactivate the preview window 1015. The instructor may then make the presentation configuration in preview window 1015 active to the selected students by clicking on the “move” button 1030, which in this case (because all of the students were selected to receive image and audio data in accordance with the new presentation configuration) completely replaces all previously created presentation configurations.

During a class, it is not unusual for all of the students in a class to receive images and/or audio data in conformance with the same presentation configuration. However, there are circumstances when it is preferable for one or more students to receive images and/or audio data in conformance with one or more different presentation configurations. For example, an instructor may create a presentation configuration that includes only himself and a student that requires individual instruction on a particular topic; the instructor may create several presentation configurations when a class is to be broken up into study groups; and the instructor may create a presentation configuration that is intended to accommodate for learning deficiencies of a student.

In the case where there is a large number of students in a class, all of the images of the students will not conveniently fit in the attendee window 1040, therefore, a limited number of image windows may be shown and the images of students may be orderly or randomly displayed during the class. Similarly, an instructor may want to create a presentation configuration that includes the images of all the students in a class. If there is a large number of students in a class then the instructor may include a limited number of image windows and have the students' images orderly or randomly shown in the windows during the class.

The active window 1045 displays the presentation configuration prescribed for one or more of the client computers. The active window 1045 shown in the exemplary presentation control screen 1000 shows that certain students are viewing student Jane Doe-1 in the left-hand side of the active window 1045 and Professor Doe in the right-hand side of the active window 1045. As noted above, the circles around student reference nos. 1-5 indicate that those students are receiving image and audio data in conformance with the presentation configuration shown in active window 1045. A tile/full-page toggle button 1050 is provided in active window 1045 so the instructor may increase the size of the active window to fill his screen or visa versa.

An instructor may give auxiliary control to an assistant (e.g., a student) so the assistant may configure presentations of image and/or audio data that is to be transmitted to one or more students' client computers. Auxiliary control may be provided by clicking on auxiliary control button 1035, which reveals command controls for setting up this option (e.g., controls for selecting an assistant, selecting the amount of control the assistant will have, identifying the images/audio the assistant will present, selecting the students that are to be under the control of the assistant). Such auxiliary control will permit the assistant to create and lead, for example, a study group, exercise group, or a project group. An assistant having auxiliary control may control the system in the same manner as the instructor, thereby enabling the assistant to more directly socialize and work with the students in a productive manner.

The system may include various control functions to facilitate the ease with which the instructor and students communicate. For example, the system may include a control function for causing the image of a speaker to enlarge on the display of the client computers of the instructor and students to a predefined size (e.g., 30% of a display size) when the speaker starts to speak so that the instructor and other students can readily recognize who is speaking. Further, the system may include a control function for allowing students to signal the instructor that they have a question. The signaling function may provide students with a “raised-hand” icon that they can click on with a mouse to cause a frame around their image on the instructor's display to flash, thereby indicating to the instructor that the student has a question. In addition, an input device such as a graphic tablet and pen (e.g., Graphire2 tablet by Waicom Technology Corp., Vancouver, Wash.) may be used with the system to further enhance the learning experience. For example, an instructor may use a graphic tablet and pen to draw sketches to demonstrate a sketching technique (e.g., foreshortening) in an art class; draw combatants' positions on a map to describe a historic battle (e.g., Battle at Gettysburg) in a history class; and write out calculations to show the development of an equation (e.g., Pythagorean theorem) in a math class. Students may use a graphic tablet and pen in a similar fashion. Alternatively, the instructor may use an electronic pen to mark up videos or maps that are presented to students to further reinforce aspects of the lecture.

FIG. 11 shows an exemplary screenshot of a presentation screen 1100. It is notable that the presentation screen 1100 is the same as that shown in the active window 1045 of exemplary presentation control screen 1000, which is seen by the students identified by reference nos. 1-5. The presentation screen 1100 includes video of student Jane Doe-1 on the left-hand side of the presentation screen 1100 and video of Professor Doe on the right-hand side of the presentation screen 1100. A “raised-hand” icon 1110 is shown in the bottom right-hand corner of the presentation screen 1100. As noted above, a student may click on the raised-hand icon 1110 to signal the instructor that he has a question. When a student in a class clicks on the raised-hand icon 1110, other members of the class may receive an indication that an answer to a question is being requested.

Referring to FIG. 12, a flow diagram shows a detailed embodiment of a method for using the presentation control system. In describing the detailed embodiment reference is made to the exemplary screenshot of presentation control screen 1000 shown in FIG. 10. It is notable, however, that other manifestations of the control screen may be used to practice the system and method of the present invention.

At step 1205 an instructor logs on to the system and at step 1210 the instructor accesses the presentation control screen 1000. It is intended that the system may have a voice-activation option wherein the presentation control screen 1000 may be voice activated so that the instructor can, for example, conveniently change presentation configurations by giving voice commands. This option is advantageous when an instructor is making multiple presentation configuration changes such as when the instructor is showing a series of still images.

At step 1215 the instructor is prompted to select or adjust system settings. Such settings include, for example: adding images/audio to or removing images/audio from the image/audio selection window 1010; setting a default to cause a student's image to automatically appear in other students' presentation screens when the student is selected to ask or answer a question; setting a default to cause the images of students in a large class to be shown orderly or randomly on a limited number of display windows in the students' presentation screens; turning on/off an option for voice-activation of the presentation control screen 1000; turning on/off an option for real-time language translation as an instructor/student speaks. If the instructor desires to select or adjust any of the settings then the instructor proceeds to step 1220 where he can make such changes and thereafter proceeds to step 1225. If, at step 1215, the instructor decides not to select or adjust such settings then he proceeds directly to step 1225.

At step 1225 the instructor is prompted to provide auxiliary control to one or more assistants. If the instructor desires to provide auxiliary control he proceeds to step 1230 by selecting the auxiliary control selection button 1035 in the configuration panel 1005 and selects an assistant, his controls, and students he is to control. By providing auxiliary controls, the assistant receives a presentation control screen substantially similar to the presentation control screen 1000 used by the instructor. The instructor will elect to provide auxiliary controls to an assistant, for example, when the instructor wants the assistant to lead a study group, exercise group, or extracurricular activity, or tutor another student. After an assistant has been given auxiliary control at step 1230 the instructor proceeds to step 1235. If, at step 1225, the instructor does not desire to provide auxiliary control to an assistant then the instructor proceeds directly to step 1235.

At step 1235 the instructor creates and configures a preview window 1015 by utilizing the controls in the configuration panel 1005 as described above and proceeds to step 1240. If the instructor desires that the presentation configuration as shown in the preview window 1015 is to be provided to all of the students then the instructor clicks on the student selection button 1020, selects all of the students, and proceeds to step 1245 by selecting the “move” button 1030, at which time the presentation configuration in the preview window 1015 moves to the active window 1045 and is available to the selected students. The instructor may then select the tile/full-page toggle button 1050 to enlarge the active window 1045 to fill his entire screen and proceed to step 1250 to start a lecture.

At step 1270 the instructor may end the lecture or momentarily discontinue the lecture in order to, for example, provide auxiliary control to an assistant or create another presentation configuration. If, at step 1270, the instructor decides to end the lecture then he proceeds to step 1275 to exit the presentation control screen 1000 (e.g., by logging off the presentation control system). If, at step 1270, the instructor decides to momentarily discontinue the lecture then he may proceed to step 1225 and continue as described above.

If, at step 1240, the instructor desires not to provide the presentation configuration as shown in preview window 1015 to all of the students, then, at step 1255, the instructor clicks on the student selection button 1020 and selects only those particular students that he desires to provide the presentation configuration and proceeds to step 1260 by selecting the “move” button 1030. As an example, in FIG. 10 it is shown that the instructor selected only students having reference nos. 1-5 (the circled reference numbers) to receive images and/or audio data in conformance with the presentation configuration shown in active window 1045. Thereafter, at step 1265, the instructor confirms whether or not all of the students are receiving images and/or audio data in conformance with a presentation configuration. If, at step 1265, all of the students are receiving images and/or audio data in conformance with a desired presentation configuration then the instructor may proceed to step 1250 and start the lecture. If, at step 1265, all of the students are not receiving images and/or audio data in conformance with a desired presentation configuration then the instructor may proceed to step 1225 and proceed as described above.

The system may keep a recording of each class. Such recordings may be useful, for example, for review by students that are unable to attend a class; for review by students in preparation for a test; for review by the instructor to prepare tests; to document misbehavior that occurs during a class. The system may include automated means for making such recordings and enabling the instructor/students to access such recordings.

From the detailed description provided above it should be readily apparent to those of ordinary skill in the art that the present invention is a significant improvement over prior art distance learning systems. A system and method is disclosed that substantially simplifies the process of developing a lesson plan that is directed toward the educational goals of a student. In addition, a system and method is disclosed that substantially enhances synchronous distance learning classes, thereby providing many of the benefits of a face-to-face class experience which is lost in most distance learning classes. Furthermore, a system and method is disclosed that ensures that any tests taken by a student for a class through the distance learning system are in fact taken by the student that signed up for the class, thereby substantially improving the credibility of the distance learning system. The system and method may also be used to ensure the identity of a student during a privileged communication between, for example, a counselor and a student.

Although the present invention has been described in detail with respect to certain embodiments and examples, variations and modifications exist which are within the scope of the present invention as defined in the following claims.

What is claimed is:

1. A method for developing a lesson plan over an electronic network, comprising:
receiving background data of a user;
receiving course data from one or more course providers;
applying a rule set to the background data and course data to determine a lesson plan that includes two or more courses identified by the course data received from the one or more course providers; and
transmitting the lesson plan for use by the user.

2. A method as recited in claim 1, wherein the background data includes data selected from the group consisting of a goal, profile information, and an academic record of the user.

3. A method as recited in claim 2, wherein the goal is selected from the group consisting of course work in modern art, a certificate in automotive repair, preparation for the Engineer-In-Training examination, bachelor's degree in software engineering, and meeting the objectives of an Individualized Educational Program.

4. A method as recited in claim 2, wherein the profile information is information selected from the group consisting of age, languages spoken, and working schedule.

5. A method as recited in claim 2, wherein the academic record is information selected from the group consisting of: results from a learning difference evaluation; scores from a WISK test, NEDT, GED, SAT, MCAT, and LSAT; transcripts from pre-kindergarten, kindergarten, primary school, high school, college and graduate/professional school; comments or evaluations from an instructor, tutor, advisor and psychologist; and grades received for courses completed following previously-developed lesson plans.

6. A method as recited in claim 1, wherein the course providers are selected from the group consisting of instructors and learning institutions.

7. A method as recited in claim 1, wherein rules in the rule set are provided by one or more of the course providers.

8. A method as recited in claim 1, wherein the rule set includes rules selected from the group consisting of course curriculum-building rules, course time-bar rules, GPA threshold rules, prerequisite rules, course/course conflict rules, and work/course conflict rules.

9. A method as recited in claim 1, further including the step of transmitting course videos, exercises, or tests to the user in accordance with the lesson plan.

10. A method as recited in claim 1, further including the step of receiving data from the user identifying one of the course providers whose course data is to be used to make up the lesson plan.

11. A method as recited in claim 1, further including the step of transmitting one or more specialized tests to the user to evaluate the user's deficiencies in selected topics.

12. A method as recited in claim 1, further including the step of transmitting the lesson plan to one or more course providers so the one or more course providers may offer bids to provide one or more courses in the lesson plan.

13. A method as recited in claim 1, further including the step of receiving a modified version of the lesson plan from a person selected from the group consisting of the user, an instructor, and an IEP Team member.

14. A system for developing a lesson plan over an electronic network, comprising:
(a) a memory for storing background data of a user, course data, and a rule set; and
(b) a processor in communication with the memory, wherein the processor is operative to
(i) receive background data of a user,
(ii) receive course data from one or more course providers,
(iii) apply a rule set to the background data and course data to determine a lesson plan that includes two or more courses identified by the course data received from the one or more course providers, and
(iv) transmit the lesson plan for use by the user.

15. A system as recited in claim 14, wherein the background data includes data selected from the group consisting of a goal, profile information, and an academic record of the user.

16. A system as recited in claim 15, wherein the goal is selected from the group consisting of course work in modern art, a certificate in automotive repair, preparation for the Engineer-In-Training examination, bachelor's degree in software engineering, and meeting the objectives of an Individualized Educational Program.

17. A system as recited in claim 15, wherein the profile information is information selected from the group consisting of age, languages spoken, and working schedule.

18. A system as recited in claim 15, wherein the academic record is information selected from the group consisting of: results from a learning difference evaluation; scores from a WISK test, NEDT, GED, SAT, MCAT, and LSAT; transcripts from pre-kindergarten, kindergarten, primary school, high school, college and grad/professional school; comments or evaluations from an instructor, tutor, advisor and psychologist, and grades received for courses completed following previously-developed lesson plans.

19. A system as recited in claim 14, wherein the course providers are selected from the group consisting of instructors and learning institutions.

20. A system as recited in claim 14, wherein rules in the rule set are provided by one or more of the course providers.

21. A system as recited in claim 14, wherein the rule set includes rules selected from the group consisting of course curriculum-building rules, course time-bar rules, GPA threshold rules, prerequisite rules, course/course conflict rules, and work/course conflict rules.

22. A system as recited in claim 14, wherein the processor is further operative to transmit course videos, exercises, or tests to the user in accordance with the lesson plan.

23. A system as recited in claim 14, wherein the processor is further operative to receive data from the user identifying one of the course providers whose course data is to be used to make up the lesson plan.

24. A system as recited in claim 14, wherein the processor is further operative to transmit one or more specialized tests to the user to evaluate the user's deficiencies in selected topics.

25. A system as recited in claim 14, wherein the processor is further operative to transmit the lesson plan to one or more of the course providers so the one or more of the course providers may offer bids to provide one or more courses in the lesson plan.

26. A system as recited in claim 14, further including the step of receiving a modified version of the lesson plan from a person selected from the group consisting of the user, an instructor, and an IEP Team member.

27. A system for developing a lesson plan over an electronic network, comprising:
means for receiving background data of a user;
means for receiving course data from one or more course providers;
means for applying a rule set to the background data and course data to determine a lesson plan that includes two or more courses identified by the course data received from the one or more learning institutions; and
means for transmitting the lesson plan for use by the user.

28. A method for an instructor to control a presentation of image and/or audio data on one or more client computers of students attending a distance learning class, the method comprising:
providing controls to an instructor that enable the instructor to configure the presentation of image and/or audio data on one or more client computers of students attending a distance learning class;
receiving from the instructor control data that represents a first presentation configuration and identifies at least one of the one or more client computers that are to receive image and/or audio data in conformance with the first presentation configuration; and
transmitting image and/or audio data in conformance with the first presentation configuration to the at least one of the one or more client computers.

29. A method as recited in claim 28, further including the step of receiving from the instructor control data that represents a second presentation configuration and identifies at least one or more client computers that are to receive image and/or audio data in conformance with the second presentation configuration.

30. A method as recited in claim 29, wherein less than all of the client computers receive image and/or audio data in conformance with the first presentation configuration and the remainder of the client computers receive image and/or audio data in conformance with the second presentation configuration.

31. A method as recited in claim 28, further including the steps of receiving from the instructor control data that identifies an assistant that is to receive auxiliary controls and providing the auxiliary controls to the assistant so the assistant can configure the presentation of image and/or audio data on one or more client computers of students attending the distance learning class.

32. A method as recited in claim 31, wherein the assistant is a student attending the distance learning class.

33. A method as recited in claim 31, wherein the assistant receives auxiliary controls for a purpose selected from the group consisting of leading a study group, leading an exercise group, and tutoring a student.

34. A method as recited in claim 28, wherein the controls provided to the instructor include a presentation control screen having a configuration panel, an active window, and an attendee window.

35. A method as recited in claim 28, wherein the distance learning class is a synchronous distance learning class.

36. A method as recited in claim 28, wherein the image data is selected from the group consisting of image data of the instructor, image data of one or more students, image data of a video presentation, or any combination thereof.

37. A method as recited in claim 28, wherein the audio data is selected from the group consisting of audio data of the instructor's voice, audio data of one or more students' voices, audio data of an audio presentation, or any combination thereof.

38. A method as recited in claim 28, wherein the distance learning class is conducted over the Internet.

39. A method as recited in claim 28, wherein the first presentation configuration includes images and audio of the instructor and images of the students attending the distance learning class.

40. A method as recited in claim 28, wherein the distance learning class is for a course of study selected from the group consisting of course work in modern art, certificate in automotive repair, preparation for the Engineer-In-Training examination, and a bachelor's degree in software engineering.

41. A system enabling an instructor to control a presentation of image and/or audio data on one or more client computers of students attending a distance learning class, the system comprising:
(a) a memory for storing image and/or audio data, and control data; and
(b) a processor in communication with the memory, wherein the processor is operative to
(i) provide controls to an instructor that enable the instructor to configure the presentation of image and/or audio data on one or more client computers of students attending a distance learning class,
(ii) receive from the instructor control data that represents a first presentation configuration and identifies at least one of the one or more client computers that are to receive image and/or audio data in conformance with the first presentation configuration, and
(iii) transmit image and/or audio data in conformance with the first presentation configuration to the at least one of the one or more client computers.

42. A system as recited in claim 41, wherein the processor is further operative to receive from the instructor control data that represents a second presentation configuration and identifies at least one or more client computers that are to receive image and/or audio data in conformance with the second presentation configuration.

43. A system as recited in claim 42, wherein less than all of the client computers receive image and/or audio data in conformance with the first presentation configuration and the remainder of the client computers receive image and/or audio data in conformance with the second presentation configuration.

44. A system as recited in claim 41, wherein the processor is further operative to receive from the instructor control data that identifies an assistant that is to receive auxiliary controls, and provide the auxiliary controls to the assistant so the assistant can configure the presentation of image and/or audio data on one or more client computers of students attending the distance learning class.

45. A system as recited in claim 44, wherein the assistant is a student attending the distance learning class.

46. A system as recited in claim 44, wherein the assistant receives auxiliary controls for a purpose selected from the group consisting of leading a study group, leading an exercise group, and tutoring a student.

47. A system as recited in claim 41, wherein the controls provided to the instructor include a presentation control screen having a configuration panel, an active window, and an attendee window.

48. A system as recited in claim 41, wherein the distance learning class is a synchronous distance learning class.

49. A system as recited in claim 41, wherein the image data is selected from the group consisting of image data of the instructor, image data of one or more students, image data of a video presentation, or any combination thereof.

50. A system as recited in claim 41, wherein the audio data is selected from the group consisting of audio data of the instructor's voice, audio data of one or more students' voices, audio data of an audio presentation, or any combination thereof.

51. A system as recited in claim 41, wherein the distance learning class is conducted over the Internet.

52. A system as recited in claim 41, wherein the first presentation configuration includes images and audio of the instructor and images of the students attending the distance learning class.

53. A system as recited in claim 41, wherein the distance learning class is for a course of study selected from the group consisting of course work in modem art, certificate in automotive repair, preparation for the Engineer-In-Training examination, a bachelor's degree in software engineering, and objectives of an IEP.

54. A system enabling an instructor to control a presentation of image and/or audio data on one or more client computers of students attending a distance learning class, the system comprising:
means for providing controls to an instructor that enable the instructor to configure the presentation of image and/or audio data on one or more client computers of students attending a distance learning class;
means for receiving from the instructor control data that represents a first presentation configuration and identifies at least one of the one or more client computers that are to receive image and/or audio data in conformance with the first presentation configuration; and
means for transmitting image and/or audio data in conformance with the first presentation configuration to the at least one of the one or more client computers.

55. A method for an instructor to control a presentation of image and/or audio data on one or more client computers of students attending a distance learning class, the method comprising:
receiving presentation controls to configure the presentation of image and/or audio data on one or more client computers of students attending a distance learning class;
with the presentation controls, creating a presentation configuration and associating at least one of the one or more client computers with the presentation configuration; and
transmitting control data representing the presentation configuration and the associated at least one of the one or more client computers to a server computer that has access to the image and/or audio data.

56. A method for ensuring the identity of a student taking a test over an electronic network, comprising:
transmitting a test to a client computer of a student;
receiving a first set of data representative of a physical characteristic of the student;
comparing the first set of data to a second set of data representative of the physical characteristic of the student to verify the identity of the student, wherein the identity of the student is verified when the first set of data matches the second set of data;
receiving a continuous stream of confirmation data of the student that begins at a time about when the first set of data was created and ends at a time about when the test is completed by the student; and
analyzing the continuous stream of confirmation data to ensure the confirmation data satisfies one or more predefined rules.

57. A method as recited in claim 56, wherein the first and second sets of data include data selected from the group consisting of scanned face image data, finger print data, hand geometry data, iris data, retina data, hand vein data, and recorded voice data.

58. A method as recited in claim 56, wherein the continuous stream of confirmation data is a continuous stream of video data.

59. A method as recited in claim 58, wherein the continuous stream of video data has a frame rate selected from the group consisting of about 30 frames/second, 1 frame/second, and 1 frame/3 seconds.

60. A method as recited in claim 58, wherein the one or more predefined rules require an average gray-scale value of a region-of-interest in the video data to remain within a predetermined range, and further including the step of initiating a signal when the average gray-scale value of the region-of-interest deviates beyond the predetermined range.

61. A method as recited in claim 60, wherein the average gray-scale value of the region-of-interest is calculated from each frame of video data.

62. A method as recited in claim 56, further including the step of transmitting a signal to the client computer that causes the test to terminate when the confirmation data does not satisfy the one or more predefined rules.

63. A method as recited in claim 56, further including the step of receiving the completed test from the student.

64. A method as recited in claim 56, wherein the continuous stream of confirmation data is a continuous stream of biometric data, and wherein the one or more predefined rules require the continuous stream of biometric data to remain consistent.

65. A method for ensuring the identity of a student taking a test over an electronic network, comprising:
receiving a test from a server computer;
receiving a first set of data representative of a physical characteristic of a student;
transmitting the first set of data to the server computer, wherein the first set of data is compared to a second set of data representative of the physical characteristic of the student to verify the identity of the student;
receiving a continuous stream of video data of the student that begins at a time about when the first set of data was received and ends at a time about when the test is completed by the student; and
terminating the test when the continuous stream of video data does not satisfy one or more predefined rules.

66. A method as recited in claim 65, wherein the first and second sets of data include data selected from the group consisting of scanned face image data, finger print data, hand geometry data, iris data, retina data, hand vein data, and recorded voice data.

67. A method as recited in claim 65, further including the step of analyzing the continuous stream of video data to determine if the video data satisfies the one or more predefined rules.

68. A method for ensuring the identity of a first person when communicating with a second person over an electronic network, comprising:
establishing communication between a first person and a second person;
receiving a first set of data representative of a physical characteristic of the first person;
comparing the first set of data to a second set of data representative of the physical characteristic of the first person to verify the identity of the first person;
receiving a continuous stream of confirmation data of the first person that begins at a time about when the first set of data was created and ends at a time about when the communication between the first person and the second person is terminated; and
analyzing the continuous stream of confirmation data to ensure the confirmation data satisfies one or more predefined rules.

69. A method as recited in claim 68, wherein the first and second sets of data include data selected from the group consisting of scanned face image data, finger print data, hand geometry data, iris data, retina data, hand vein data, and recorded voice data.

70. A method as recited in claim 68, wherein the continuous stream of confirmation data is a continuous stream of video data.

71. A method as recited in claim 68, wherein the continuous stream of confirmation data is biometric data, and wherein the one or more predefined rules require the continuous stream of biometric data to remain consistent.

72. A method as recited in claim 68, wherein the step of establishing communication between a first person and a second person is initiated by one of the first person and the second person sending an electronic message to the other of the first person and the second person.

73. A method as recited in claim 68, further including the step of transmitting a signal to the second person that confirms the identity of the first person.

74. A method as recited in claim 73, wherein the confirmation signal is received by the second person throughout the communication between the first person and the second person.

75. A method as recited in claim 68, wherein the first person and the second person are selected from a group consisting of a counselor and student, doctor and patient, psychologist and patient, attorney and client, husband and wife, parent and teacher, and a minister and penitent.
